(19) United States
(12) Patent Application Publication
(10) Pub. No.: US 2018/0057244 A1
(43) Pub. Date: Mar. 1, 2018

(54) RAPID HEATING RATE ARTICLE FOR MICROWAVE METHODS

(71) Applicant: Corning Incorporated, Corning, NY (US)

(72) Inventors: Heather Debra Boek, Corning, NY (US); Kirk Richard Colvin, Corning, NY (US); Robert Arturo Craig, Big Flats, NY (US); Michael S. Pambianchi, Corning, NY (US); Rebecca Lynn Schulz, Horseheads, NY (US)

(21) Appl. No.: 15/683,232

(22) Filed: Aug. 22, 2017

Related U.S. Application Data
(60) Provisional application No. 62/378,425, filed on Aug. 23, 2016.

(51) Int. Cl. B65D 81/34; B65D 81/26; B01L 3/00

(52) U.S. Cl. CPC B65D 81/3446; B65D 81/264; B01L 3/50851; B65D 2581/3454; B65D 2581/3445; B65D 2581/3452; B65D 2581/3472; B65D 2581/3474; B65D 2581/3478; B65D 2581/3479; B65D 2581/3448

(57) ABSTRACT

A microwave susceptor article having an advantageous microwave heating rate property and cooling rate property, including: a substrate; a metallic-containing layer on at least one major surface of the substrate; and optionally a protective coating on or associated with the metallic layer, as defined herein. Also disclosed are a method of making the article and a method of using the article.

This application claims the benefit of priority under 35 U.S.C. §119 of U.S. Provisional Application Ser. No. 62/378,425 filed on Aug. 23, 2016 the content of which is relied upon and incorporated herein by reference in its entirety.

The entire disclosure of each publication or patent document mentioned herein is incorporated by reference.

### BACKGROUND

The disclosure relates to an article and microwave methods.

### SUMMARY

In embodiments, the disclosure provides an article having a rapid heating rate, a method of making the article, and methods of using the article in rapid microwave heating applications.

### BRIEF DESCRIPTION OF THE DRAWINGS

In embodiments of the disclosure:

FIG. 1 shows an example structure, in a cross-section view, of a disclosed rapid heating rate article (100).

FIG. 2 shows a thermal image, recorded during heat up, of an exemplary rapid heating article having a metallic layer pattern.

FIG. 3 shows a thermal image during heat up assessment of another exemplary rapid heating article having a food article present.

FIG. 4 shows a graph of the measured heating rate of the metallic layer on the ceramic substrate for the article imaged in FIG. 3.

FIG. 5 shows a partially exploded, cross-section view of an exemplary rapid heating rate article (600).

FIG. 6 shows a partially exploded, cross-section view of another example rapid heating rate article (700).

FIG. 7 shows a partially exploded, cross-section view of another example rapid heating rate article (800) having a “face-to-face” sandwich structure.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

In embodiments, the disclosed method of making and using provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

Definitions

“Heating rate” and like terms refer to, for example, the increase or change in temperature of a microwave susceptor article when an article is irradiated with a microwave source divided by the amount of time the article is irradiated with a specified microwave source (e.g., 2.45 GHz microwave operating at 1200 W).

“Cooling rate” and like terms refer to, for example, the decrease or change in temperature of a microwave susceptor article when the susceptor article that has been previously irradiated with a microwave source and heated to a specified elevated temperature is allowed to passively cool in ambient air and divided by the amount of time it takes for the article at the specified elevated temperature to return to ambient temperature.

“Susceptor” and like terms refer to, for example, an article that can enhance microwave treatment (e.g., heating, drying, browning, cooking, fusing, etc.) of a work piece (e.g., as defined herein). A susceptor is typically in close proximity to a work piece or in direct physical contact to a work piece (see Bhattacharya, M., et al., Energy 97 (2016) 306-338). The susceptor article is distinct from a work piece.

“Work piece” and like terms refer to, for example, the object (e.g., a food article, a green body, etc.) being worked on, acted upon, or exposed to microwave radiation, for example, for the purpose of heating, drying, curing, cooking, browning, sintering, annealing, and like application, or combinations thereof.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The article and methods of the disclosure can include any value or any combination of the values, specific values, more specific values, and preferred values described herein, including explicit or implicit intermediate values and ranges.

In embodiments, the disclosure provides a microwave susceptor article comprising: a substrate (e.g., Corelle® laminates; glass, glass-glass laminates, glass-ceramics; or combinations of the laminates and glass-ceramics) having a thickness of, e.g., from 2 to 10 mm, e.g., for single layer substrates; and a metallic-containing layer having a thickness of 10 to 800 nanometers, preferably 10 to 150 nm, e.g., for single layer metallic-containing single layer substrates, including intermediate values and ranges, on at least one major surface of the substrate.

In embodiments, the article can have a heating rate of, for example, from 8 to 45° C./sec, i.e., capable of achieving a temperature of from 500 to 700° C., for example, greater than or equal 670° C. in less than 30 seconds, e.g., 11° C./sec for a laminate coated with stainless steel (e.g., thickness of from 15 to 40 nm), or a glass coated with a 30 wt % aluminum frit, with a heating rate of from 20 to 30° C. per sec. e.g., 22° C. per sec.

In embodiments, the microwave energy to achieve the microwave heating rate can be, for example, from 50 to 2000 W, and the microwave source frequency can be, for example, selected from 915 MHz, 2.45 GHz, 5.8 GHz, or combinations thereof.

In embodiments, the microwave energy to achieve the microwave heating rate can be, for example, from 1000 to 1400 W, and the microwave source frequency was 2.45 GHz

In embodiments, the microwave irradiating or irradiation can be sufficient to produce a temperature increase in the article, for example, from ambient to at least one of:

from 500 to 670° C. in 60 seconds;

from 500 to 670° C. in 30 seconds; or

from 500 to 670° C. in 20 seconds.

In embodiments, the article can include, for example, a substrate of a glass-laminate, and a metallic-containing layer or metalloid compound-containing layer is selected from, for example, steel, aluminum, titanium, or combinations thereof.

In embodiments, the article, such as a glass-laminate substrate and having a metallic-containing layer, can have a rapid cooling rate that is capable of quickly cooling, for example, cooling down from an elevated temperature of about 500 to 700° C., e.g., 500 to 670° C., to from 20 to 30° C., i.e., ambient temperature, in from 10 to 30 seconds, in from 10 to 20 seconds, and in from 10 to 15 seconds, including intermediate values and ranges, after termination of the microwave irradiation.

In embodiments, the article can have a cooling rate, for example, of from 10° C. per second to 75° C. per second.

In embodiments, the article can have a substrate having: a thermal conductivity of from 0.002 to 0.004 Cal/cm−sec-° C., e.g., 0.003 Cal/cm−sec-° C.; a modulus of rupture (MOR) of from 40 to 550 MPa; and a coefficient of thermal expansion (CTE) of from 0 to 92×10⁻⁷/° C., which range includes substrates, for example, beta-spodumene, glass laminate, fused silica, e.g., HPFS®, and a low emissivity glass, e.g., ULE®.

In embodiments, the article can have a metallic containing layer that includes at least one of, e.g., a metal sheet, a metal particle, a metal wire, a metal coil, a metal wool, a metal fiber, metal coated fibers, a metal coated particles, and like metal forms, or a combination thereof.

In embodiments, the article can further comprise, for example, a protective layer on the metallic-containing layer or over the metallic-containing layer, e.g., to prevent oxidation of the surface of the metallic layer.

In embodiments, the substrate can have, for example, a thickness of from 2 to 6 mm, more preferably of from 2 to 4 mm thick, and the metallic-containing layer having a thickness of from 10 to 500 nanometers, and more preferably of from 10 to 150 nanometers in thickness or depth.

In embodiments, the substrate can be, for example, a sheet or monolithic structure of, e.g., a glass, a glass laminate, a glass/glass laminate, a glass ceramic, a glass/glass ceramic, a ceramic, and like materials, or a combination thereof, more preferably a glass-laminate where the coated glass-laminate structure is capable of repeated rapid thermal cycling without loss of strength or thermal shock. In embodiments, the glass-laminate is capable of cooling very quickly, for example, cooling to ambient temperature in approximately 10 to 15 seconds, in ambient air, after termination of the microwave irradiation. While other materials may also possess these attributes (e.g., HPFS®, ULE®) they may be less practical because of their higher cost. Some glass-ceramic compositions (e.g., Pyroceram®) are also suitable as substrates, but are disadvantaged by an inability to dissipate heat as rapidly as a laminated glass substrate. In embodiments, the substrate sheet can be, for example, a flat or planar geometry, a concave or convex form, and like geometric shape variations, or combinations thereof.

In embodiments, the metallic-containing layer can be, for example, selected from a sputtered metal, a sprayed metal, a printed metal, a vapor deposited metal, and like layers, or a combination thereof. The metallic containing layer can be applied to one or more of the surfaces of the substrate as a continuous solid or, for example, in a pattern created via, e.g., screen printing or a printing device. In embodiments, the coating may be sprayed or brushed on. The metallic-containing layer can be, for example, 10 to 800 nm in depth when applied by sputtering from a metallic target. When the layer is applied via spraying or brushing, a glaze with a metallic content of from about 25 to 50 wt % based on the weight of the glaze formulation can be preferred. In embodiments, the metallic material in the metallic-containing layer can be, for example, a coil, a chip, a particle, a flake, a wire, a metallic wool, a metallic fabric, and like form factors, or combinations thereof. In the embodiments, the metallic material can be dispersed, interspersed, coated, or like dispositions, between one or more of a plurality of substrate layers that are adhered with a glaze or similar material with a matching coefficient of thermal expansion.

In embodiments, the metallic-containing layer can be, for example, selected from tin, tungsten, titanium, copper, molybdenum, silver, stainless steel, and like metals or metalloids, or a combination thereof.

In embodiments, the protective layer can prevent oxidation of the metal in the metallic containing layer. The protective layer can be selected from a number of materials that are, for example, transparent to microwave energy at lower temperatures (e.g., less than 1000° C.) such as silica or alumina, or a mixture thereof.

In embodiments, the article can have, for example, an additional or a plurality of substrates having one or more of interleaved, e.g., compiled with, metallic-containing layers situated between each of the adjacent substrates.

In embodiments, the additional substrate can function as or be used as a protective layer for a coated substrate, or to enclose a bonded or un-bonded layer of a metallic-containing layer. Furthermore, although not limited by theory, it is believed that additional substrate layer(s) while increasing the cost of the article, can extend the useful life of the article by reducing oxidation of the metallic component(s).

In embodiments, the disclosure provides a method of making the above mentioned article comprising, consisting essentially of, or consisting of:

depositing at least a metallic-containing material to form a metallic-containing layer on the substrate.

In embodiments, the depositing at least the metallic-containing material on the substrate can comprise, for example:

sputter coating a metallic source to form a metallic layer on the substrate;

spraying a glaze formulation containing, e.g., from 25 to 50 wt % metallic particles on the surface of the substrate; brushing a glaze formulation containing, e.g., from 25 to 50 wt % metallic particles on the surface of the substrate; or a combination thereof, such as iron, aluminum, tin, copper, titanium. In embodiments, a glass frit can be formulated to closely match the coefficient of thermal expansion of the desired substrate. The frit can then be mixed in appropriate proportions with the metallic-containing component and a dispersing medium is added, if necessary, as determined by the application method. The frit/metallic glaze formulation can be applied to the substrate via any suitable application method (e.g., air or airless spraying, dip, flow, curtain, roll, powder coating, curtain coating, electrostatic deposition, and like methods). A subsequent heat treatment or irradiation may be necessary to cure and adhere the glaze to the substrate depending on the application method selected. Other adhesives that are microwave safe and that are capable of withstanding the temperatures during use can be selected.

In embodiments, the disclosure provides a method of using the above mentioned microwave susceptor article comprising, for example:

irradiating, with a source of microwaves for a time, the microwave susceptor article and a work piece.

In embodiments, the time can be, for example, from 5 seconds to 10 minutes.

In embodiments, the microwave susceptor article can be, e.g., in proximity to the work piece, e.g., 0.01 to 10 mm, the microwave susceptor article is in direct physical contact with the work piece, or both.

In embodiments, the microwave susceptor article can be, for example, in proximity to the work piece e.g., from 0.01 mm to 10 mm, but not in direct physical contact.

In embodiments, the microwave susceptor article can be, for example, in direct physical contact with at least a portion of the work piece.

In embodiments, the work piece can be selected from at least one of, for example: a food item, a wet ceramic body, a ceramic green body, concrete, terrazzo, timber, milled lumber, lumber composites (e.g., green plywood), and like materials, or combinations thereof.

In embodiments, if one desires to use the rapid heating rate article for heating a food item, the food can be placed in contact with the metallic coating, or the protected metal coating, or the top or bottom layer of a disclosed layered article, and exposed to microwave radiation for a specified period of time until the food is cooked and the food item has attained the desired color and texture. If one desires to crisp or brown both sides of the food item, then the food item can optionally be inverted, for example, rotated 180° about a horizontal axis (e.g., flipped or turned over) about half-way through the irradiation cooking interval. Alternatively, the food item can be bounded on two opposite sides, e.g., with one or more of the disclosed susceptors on each side. The irradiation cook time can strongly depend on, e.g., the type of food item, the amount of food item to be cooked, and the power limitations and magnetron configuration of the microwave device. In embodiments, the rapid heating article in combination with a work piece can be irradiated by two or more microwave sources, for example, one source above and a second below the work piece, and can be microwave irradiated for example, simultaneously, sequentially, or alternatingly. In embodiments, there can be relative motion between the microwave source and the work piece to, e.g., facilitate uniform irradiation and heating of the work piece, and to minimize overheating the work piece, or avoiding excessive or isolated hot spots.

In embodiments, the irradiating can be, for example, sufficient to produce a heating rate of from 500 to 670° C. in 60 seconds.

In embodiments, the irradiating can be, for example, sufficient to produce a heating rate of from 500 to 670° C. in 30 seconds.

In embodiments, the article can reduce the time needed to cook a food item, brown a food item, or both, when compared to cooking the foodstuff without the disclosed article present.

The present disclosure is advantaged is several aspects, including for example, providing:

a rapid heating rate article for use in a microwave environment having a high heating rate of from 8 to 45° C. per second, e.g., achieving a temperature of greater than or equal to 670° C. in less than about 10 to 60 secs, such as 30 seconds;

a rapid cooling rate article for use in a microwave environment;

a substrate capable of withstanding a rapid heating/cooling cycle without thermal shocking;

a metallic-containing component having a specified coating depth or quantity, for example, for particles, wires, coils, or wool, necessary to achieve the desired heating rate;

an article that can be configured for a specific end use (e.g., a flat plate, a contoured surface, a concave or a convex form in various geometric shapes);

an operational design that permits the article to be removed from the microwave immediately after use without the need for thermal protection for an operator (user); or an article that can be used for food to achieve crisping, browning, or both, while simultaneously achieving complete cooking, i.e., suitable for human consumption, of the interior of the food item in a rapid time frame such as in from 15 sec to 2 min.

Microwave Susceptor Article and Preparation—Generally

The disclosed article has two main components: a substrate; and a metallic-containing layer comprised, for example, of a metallic coating layer or metallic structural component. The substrate can be selected, for example, from a ceramic, a glass, a glass-ceramic, a laminated structure consisting of, for example, a glass, a ceramic, a glass-ceramic, or combinations thereof. The substrate material calls for it to be stable to rapid thermal cycling over temperatures of from 25 to 670° C. Substrate materials such as Corelle®, fused silica, and other glass or glass-ceramic compositions were successfully tested. In embodiments, the substrate was preferably a laminated glass. The substrate can be a flat plate, or any design envisioned by the user such as a cylinder, a convex or concave surface with square, circular, rectangular, and like geometries, or combinations thereof. The metallic-containing layer can be selected from, for example, a metal coat of titanium, tin, tungsten, manganese, silver, copper, stainless steel, and like materials, or combinations thereof. The depth or thickness of the metal coat can be, for example, from 10 to 150 nm depending on the coating material. In an exemplary example, a stainless steel coat having a thickness of from 30 to 50 nm achieved the desired results of achieving a temperature of 500° C. in 60 sec or less as did a substrate with a titanium coating having a thickness of from 20 to 30 nm. It is significant to note that metal layer coating thickness can play a significant role in achieving the desired heating rates, and the heating rate can be varied, for example, depending upon the metallic layer thickness, the type of metallic material selected, or both.

Microwaves span the electromagnetic (EM) spectrum in the region with wavelengths ranging from one meter to one millimeter at frequencies between 300 MHz to 300 GHz. The higher the frequency, the smaller the wavelength (300 MHz has a wavelength of 100 cm while 300 GHz has a wavelength of 0.1 cm). While microwaves encompass a large portion of the EM spectrum, only certain frequencies can be used for industrial processing as dictated by the FCC to avoid interference with communication frequencies. For the US, these frequencies are primarily 915 MHz, 2.45 GHz, and 5.8 GHz. While microwave energy is used in many commercial applications, the primary use is drying, i.e., water removal. Many processes rely on the premise that water and other polar molecules are excited when exposed to microwave energy. Increased rotations of the molecules cause heat that is transferred to adjacent molecules resulting in rapid heating and the release of water vapor. As the microwaves can penetrate into certain materials, heating can be volumetric, and moisture from the inside of the part can be removed as the surface pores remain open and thus do not impede the release of water. This impedance is often the case in conventional heating which heats from the outside in. If the material being heated is transparent to microwaves, heating ceases when the water is removed. This is a very beneficial aspect in commercial enterprises effectively providing an inherent off-switch during material processing.

The four primary material and microwave interactions are: transparent (e.g., low loss insulators such as pure alumina) where microwaves pass through with little or no effect; opaque (e.g., conductors such as bulk metals) where microwaves are reflected off the surface; absorbers (e.g., water, SiC) where microwaves are readily absorbed at room temperature (e.g., 20 to 25° C.); and partial absorbers (e.g., composite mixtures of non-absorbers with absorbers) where microwaves are absorbed by one or more of the materials in the mixed composite (see Sutton, W. H., Ceramic Bulletin, 1989 68[2], 376-386).

Many materials do not absorb, or only partially absorb microwave energy at room temperature. However, as heat is applied by use of a hybrid heating system, and molecules become more mobile, microwave energy can be absorbed, increasing the heating rate of the material. The temperature at which a material begins to interact with microwave energy is referred to as the critical temperature (Tc). For example, pure alumina is transparent to microwave energy from room temperature to about 1000° C. After the alumina reaches Tc (about 1000° C.) the alumina will absorb and begin to heat due to microwave interaction. In embodiments, when the disclosed article is exposed to microwave radiation there is a rapid increase in temperature of the article caused by conductivity losses in the thin metallic film (see \check{C}esnek, January (2003) Czech Journal of Food Science, 21: 34-40). The joule heating generated from the disclosed article intensifies the surface heating of a material (i.e., work piece) placed on or within the article. In addition, a material placed on or within the article can also interact with the microwave radiation to a lesser degree.

There are numerous examples of microwave hybrid heating or microwave susceptors. Some examples mention ovens that use a combination of microwave energy together with radiant or gas heaters. Other hybrid ovens use suscepting materials such as silicon carbide. The susceptor material heats first and radiates heat to the interior of the microwave oven, and excess microwave energy is absorbed by the material (i.e., work piece) being processed. Small scale susceptors are also known, primarily for use in the food industry or for small scale laboratory experiments. For the commercial food industry, packaging may act as the susceptor. In this instance, metallized films with specified patterns and a defined resistivity are laid down on a paper or a polymer substrate. These articles serve to concentrate the microwave energy and reflect it back to the food surfaces in contact with the film. While this may appear to be simple, it is a precise balance that helps to provide additional heating to the surface of a product while still permitting sufficient radiation to heat the interior. There are also numerous examples of composite susceptors that take advantage of a mixture of absorbing and non-absorbing materials to control the net heating rate of the susceptor. (see Bhattacharya, M., supra.)

Applications that can advantageously use rapid temperature increases can include, for example: browning/crisping of food items (e.g., meats, pastries, etc.) in a microwave, sanitation, microbial sterilization, chemical reactions or reactors, the alteration of ceramic material properties (e.g., density, strength, pore structure), and industrial material processing such as crystal nucleation or crystal growth. Other potential benefits resulting from the disclosed rapid heating article and methods are, for example, decreased energy expenditures, shorter process times, and improved or unique properties imparted to the work piece resulting from processing with the disclosed article and methods.

The literature has discussed the attributes of microwave hybrid heating. Hybrid heating is of particular interest in sintering ceramics, as most of these materials are transparent to microwave energy at room temperature. In addition, conventional processing times are often measured in days rather than hours or minutes, therefore it is advantageous to be able to increase the heating rate and shorten dwell times by having a volumetric distribution of energy within the piece to be sintered. In many of the susceptor devices, silicon carbide (SiC) in the form of granules, rods, or plates, is used in conjunction with refractories to achieve the desired heating rates and dwell times. In one study, numerous materials were individually tested in a 2.45 GHz, 1000 W microwave oven (see Bhattacharya, M., supra.). The referenced test data in Table 1 showed a difference in heating rates between low loss materials such as alumina, moderate to high loss materials, and powdered metals. Heating rates as fast as 21.4° C. per sec can be achieved when using amorphous carbon as a suscepting material.

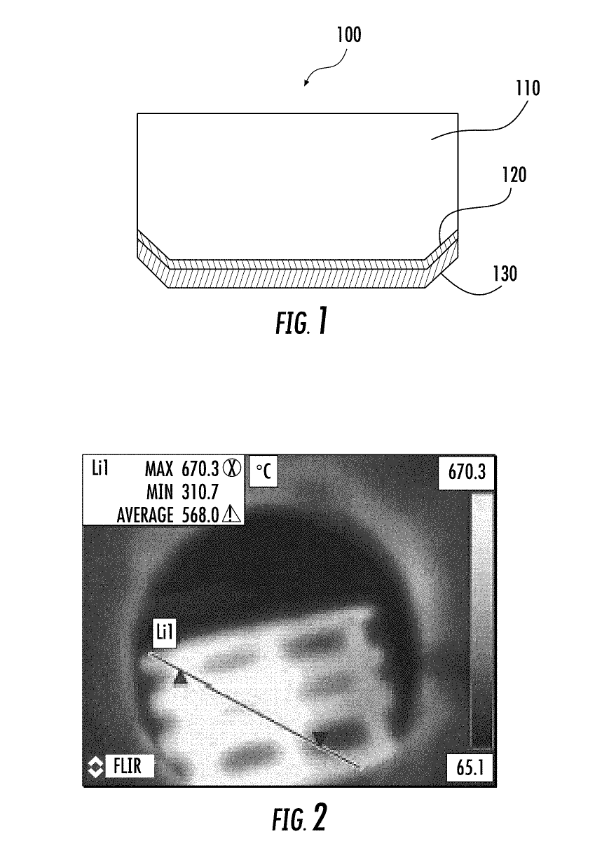

One unexpected result and superior advantage of the presently disclosed article was the observed, exceptionally high heating rate. In embodiments, it was possible to achieve a heating rate of 45° C. per sec where the substrate survived. In another instance, a heating of 62° C. per sec was achieved but the substrate melted. More routinely, a heating rate of from 8 to 22° C. per sec was observed (see FIG. 1). Heating rate experiments for the articles described in this disclosure were carried out in a 2.45 GHz microwave operating at 1200 W.

Referring to the Figures, FIG. 1 shows a structure (not to scale or relative proportions), in a cross-section view, of an example rapid heating rate article (100) having a substrate (110), a single metallic coat or a single metallic layer (120) on the surface of the substrate, and an optional protective coat (130) (e.g., a glass frit or a ceramic glaze) on the surface of the combined substrate and metallic layer. In embodiments, the metallic-containing layer (120) can include, for example, metal chips, metal particles, metal wool, metal coils, fine pieces of wire, and like metal forms, two or more metallic-containing layers, and an optional suitable binder. In embodiments, the optional protective coat (130) layer can be on the surface of the metallic-containing layer. In embodiments, the optional protective coat (130) can be mixed with the metallic layer in one or more various metal forms and situated on, e.g., coated on the surface of the substrate (110) (see also FIG. 6 (720)). In embodiments, the substrate (110) can be, for example, a flat glass, a laminated glass, a ceramic, a glass-ceramic, or combinations thereof, having a thickness of, for example, 0.5 to 10 mm, a metallic-containing layer or metallic coating (120) having a thickness of, for example, 10 to 150 nm, and optionally having a protective coat (130) to prevent metallic layer oxidation or disruption.

FIG. 2 shows a thermal image, recorded during heat up, of an exemplary rapid heating article having a metallic layer grid. In this example, the article was made of a glass-ceramic substrate having a 25 nm stainless steel sputter coat metallic layer and a 2 to 10 nm protective coating of silica over the stainless steel layer on the substrate. The grid pattern was created on the surface of the substrate using, e.g., masking tape. The masked sample was then metal sputter-coated and silica coated. The dimensions of the grid lines (i.e., the unmasked regions) were about 5.4 mm across and the open spaces (i.e., the unmasked regions that received the sputtered metal) between the gridlines were 8 to 9 mm×16 to 18 mm. The masking tape was removed and the sample article was tested in a microwave heat-up or heating rate assessment. The maximum temperature measured was in excess of 670° C., which was achieved in approximately 30 seconds by a 2.45 GHz microwave operating at 1200 W. The thermal camera used to measure the temperature had an upper limit of 670° C. This sample corresponds to Example 101 in Table 2.

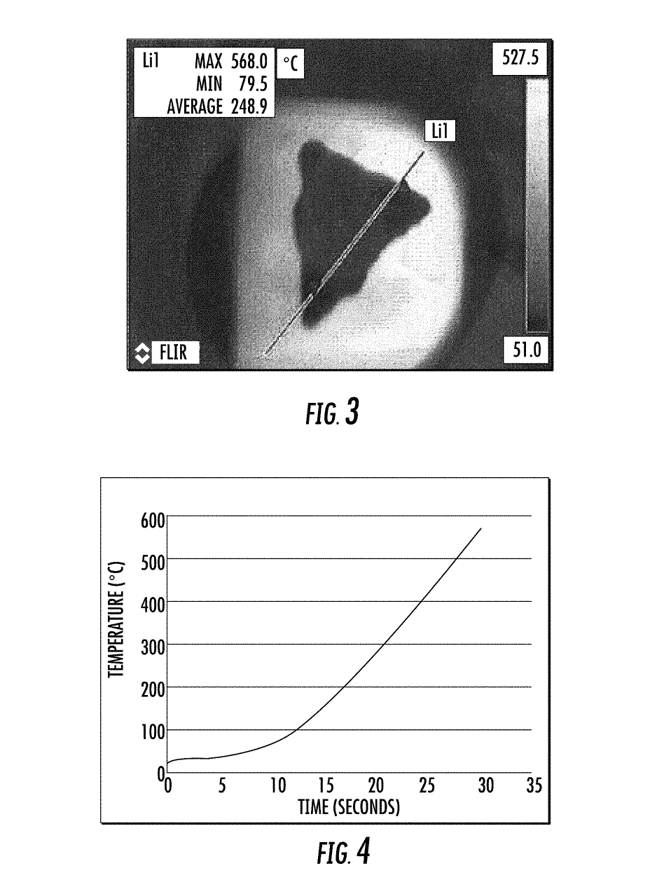

FIG. 3 shows a thermal image during microwave heat up assessment of another exemplary rapid heating article. In this example, the article was similar to that used for the measurements in FIG. 2 with the exception that the sputtered metallic coat was a 23 nm stainless steel layer in a contiguous rectangular shape over the bottom surface, rather than the grid pattern of the article of the FIG. 2 image. The substrate in the article used for the measurements in FIG. 3 and the graph of FIG. 4 was the same glass-ceramic that was used in FIG. 2. However, a frozen food article (dark triangle) (e.g., a Hot Pocket® Bite, Nestlé, USA) was placed in contact with the metallic layer and subjected to microwave radiation (1200 W, 2.45 GHz) for a period of 30 seconds. The rapid heating article of this example is not in listed in Table 2. The rapid heating article examples listed in Table 2 were measured on pristine samples in the absence of food because the initial microwave radiation heating without food tends to oxidize the metallic layer surface of the article that can result, in certain circumstances, in reduced heating rates of the article on subsequent uses.

FIG. 4 shows a graph of the heating rate (temperature vs. time) of the metallic layer on the ceramic substrate for the article imaged in FIG. 3.

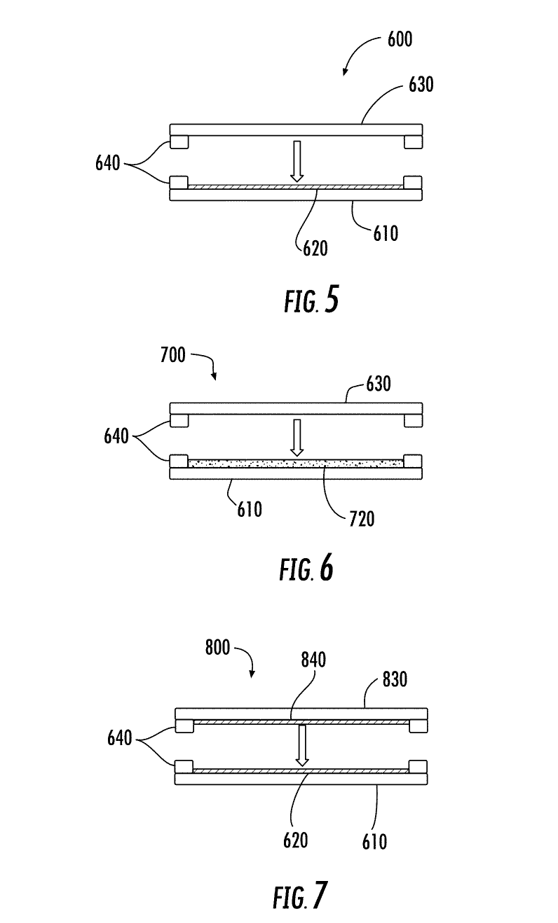

FIG. 5 shows a partially exploded, cross-section view of an exemplary rapid heating rate article (600) including, for example, a bottom substrate (610) having only a sputtered coated metallic layer (620), an uncoated top substrate (630), and a bonding layer (640) on either or both the top and bottom substrates. The bonding layer can be formed with a bonding agent, for example, a frit having coefficient of thermal expansion that closely matches the substrate. In embodiments, substrate pieces can be combined (arrow) if, for example, the frit bonding layer is heated to a softening temperature (e.g., 800 to 900° C.) and pressed together.

FIG. 6 shows a partially exploded, cross-section view of an example rapid heating rate article (700) having a sandwich structure including, for example, a bottom substrate (610) having a disintegrated metallic-containing layer (720) having, for example, metal chips, metal particles, metal fiber or metal wool, metal coils, fine pieces of wire or whiskers of wire, and like metal forms, in a binder such as a ceramic glaze, frit, or refractory cement, an uncoated top substrate (630), and a bonding layer (640) on either or both the top and bottom substrates.

FIG. 7 shows a partially exploded, cross-section view of an example rapid heating rate article (800) having a “face-to-face” sandwich structure including, for example, a bottom substrate (610) having a sputter coat metallic layer (620), a top substrate (830) having a sputter coat metallic layer (840), and a bonding layer (640) on either or both the top and bottom substrates. In embodiments, the bonding layer can be, for example, a ceramic glaze, a frit, a refractory cement, and like materials, where the bonding layer has a coefficient of thermal expansion (CET) that is close to the CET of the substrate. In the assembled article the metallic layers (620) and (840) can be adjacent with a gap or a cavity in between or the metallic layers can be in direct contact with no gap or cavity in between. In the assembled article the top and bottom substrates can be spaced apart by the intervening metallic layers and optionally can have an empty gap or cavity therebetween.

An experimental summary is contained in Table 2. The temperature measurements were limited by an upper temperature value of 670° C. of the infrared camera (FLIR). The disclosed article and method of using the article unexpectedly provided rapid microwave heating rates compared to prior art devices or articles in food or industrial applications (see e.g., U.S. Pat. No. 9,049,751, and a hybrid oven: US20100252550).

The disclosed articles and method of using the articles also unexpectedly provided relatively rapid cool down rates compared to prior art or comparative articles, for example, from about 10° C. per sec to about 75° C. per sec. Rapid cool down is a desirable and preferred property especially for consumer safety or industrial operator safety.

In embodiments, preferred disclosed articles can be a combination of materials based on criteria, for example, the cost of the substrate, the cost of the coating or additive, the durability of the article, the heating rate, the cooling rate, or a combination thereof. In embodiments, depending on the intended use of the article, such as household, industrial, or experimental research, the total cost of the article may be a factor. Additionally, if the article is used for heating food, the article must be food safe. Preferred articles that satisfy one or more the preferred criteria are listed in Table 3.

General Method of Making a Rapid Heating Article—Metallic Sputtering

A suitable substrate such as disclosed herein is selected. A 3″ round metallic medium (“target”) is selected from, for example, tin, tungsten, titanium, copper, molybdenum, silver, stainless steel, and like materials, or a combination thereof. The selected substrate is placed in a vacuum chamber (e.g., Advaco—Advanced Vacuum Co., Inc, equipped with a cryogenic pump system) and the selected target material to be sputtered is the negative cathode and is placed in the Onyx 3 Sputtering Gun, and the substrate material to be coated is the anode. The chamber is evacuated by vacuum pumping to a about 10⁻⁶ Torr and an inert gas, such as high-purity argon is introduced to the chamber. A current is applied across the target. The current (e.g., about 50 W) is supplied by an Advanced Energy RFX-600 power supply with a ATX-600 matching network. The Advaco is a sputter-up system where the substrate is placed above the sputtering gun on a substrate platen and rotated to ensure metallic coating uniformity. At the end of a specified time, the power and gas supplies are terminated, the high vacuum valve is closed, and the chamber is purged. The sputtered substrate is removed and another substrate can be installed and the process repeated.

General Method of Making a Rapid Heating Article—Having a Metallic Grid

A rapid heating article having a metallic grid can be prepared by, for example, first covering or masking portions of a surface of suitable substrate with a specified pattern with, e.g., masking tape, such as in a checker board pattern or like grid patterns. The masked substrate is then sputtered with a desired metal. Upon completion of sputtering, the tape is removed and a metallic grid pattern remains on the surface of the substrate.

### EXAMPLES

The following Examples demonstrate making, use, and analysis of the disclosed article and methods in accordance with the above general procedures.

### Comparative Examples 1 to 6

Uncoated substrate controls (Table 2, C1-C6) were exposed to 1200 W of microwave energy at 2.45 GHz for a period of 1 or more minutes. The temperature was measured with an infrared camera.

### Comparative Examples 7 to 14

Commercially available microwave heating articles (Table 2, C7-C14; commercial controls”) that are designed to cook products such as bacon or pizza, or providing a means to concentrate or focus the microwave energy in a desired location, were evaluated for heating properties for comparison with the presently disclosed articles. The temperature was measured with an infrared camera.

### Example 15

A Corning code 9696 (beta-eucryptite) glass ceramic substrate, 3 microns spherical iron powder layer (low loading, e.g., 1 to 2 g) was placed on the surface of one sheet of the glass ceramic, then a second sheet over the iron powder. The temperature was measured with k-type thermocouple. The sample arced and broke.

### Example 16

A Corning code 9696 (beta-eucryptite) glass ceramic substrate, 3 microns spherical iron powder (medium loading, e.g., 3 to 4 g) was placed on the surface of one of the sheets of the glass ceramic, then a second sheet over the iron powder. Measured temperature with k-type thermocouple, sample arced and broke.

### Example 17

A Corning code 9696 (beta-eucryptite) glass ceramic substrate, 3 microns spherical iron powder (high loading 5 to 6 g) was placed on the surface of one sheet of the glass ceramic, then a second glass ceramic substrate sheet over the iron powder. The temperature was measured with a k-type thermocouple. The sample arced and broke.

### Example 18

A Corning code 9696 (beta-eucryptite) glass ceramic substrate, silicon carbide powder (Carborex C6-100, 150 microns diameter particles—medium loading (exact amount not measured) was placed on the surface of one sheet of the glass ceramic, then a second glass ceramic sheet over the silicon carbide. The temperature was measured with a k-type thermocouple. The sample arced and broke.

### Example 19

A Corning code 9667 (beta-spodumene) glass ceramic substrate with a 6000/nm tin coating (sputtered), and a 100 ml beaker of water was added to a microwave cavity to help attenuate arcing. The coating oxidized with temperatures less than 100° C.

### Example 20

A borosilicate glass slide (Corning 2947) with a conductive silver ink pattern printed on one side was exposed to 1200 W of microwave energy at 2.45 GHz for a period of 2 min. The maximum temperature achieved as a result of the exposure was 60° C.

### Example 21

A Corning code 9667 (beta-spodumene) glass ceramic substrate was coated with a carbon paste (8 g carbon mixed with 15 mL water), followed by an overcoating of clear silica glaze. The coated article was exposed to 1200 W of microwave energy at 2.45 GHz for a period of 2 min. The maximum temperature achieved as a result of the exposure was 64° C.

### Example 22

A Corning code 9667 (beta-spodumene) glass ceramic substrate was coated with 0.16 inch outer diameter stainless steel tubes adhered to the surface of the sheet using a clear commercial glaze. The article was exposed to 1200 W of microwave energy at 2.45 GHz for a period of 2 min. The maximum temperature achieved as a result of the exposure was 71° C.

### Example 23

A high purity fused silica (HPFS®) having a conductive silver ink pattern printed on the surface was exposed to 1200 W of microwave energy at 2.45 GHz for a period of 2 min. The maximum temperature achieved as a result of the exposure was 77.4° C.

### Example 24

A Corning code 9667 (beta-spodumene) glass ceramic substrate molded to a U-shaped article was sputter-coated with silicon carbide to a depth of 300 nm. The article was exposed to 1200 W of microwave energy at 2.45 GHz for a period of 3 min. The maximum temperature achieved as a result of the exposure was 122° C.

### Example 25

A Corning code 9667 (beta-spodumene) glass ceramic substrate coated with a carbon paste (8 g carbon mixed with 15 mL water) was exposed to 1200 W of microwave energy at 2.45 GHz for a period of 2 min. The maximum temperature achieved as a result of the exposure was 82° C.

### Example 26

A Kovar® glass frit (crushed glass) mixed with 3× steel wool fibers (23 grit+0.2 g steel wool) was melted in a conventional oven overnight at 1100° C. The room temperature cooled article was exposed to 1200 W of microwave energy at 2.45 GHz for a period of 2 min. The maximum temperature achieved as a result of the exposure was 86° C.

### Example 27

A Corning code 9667 (beta-spodumene) glass ceramic substrate was coated with a mixture of GG4 carbon and commercial clear glaze (S2101), and then heated for 18 hours at 1000° C. The room temperature article was then exposed to 1200 W of microwave energy at 2.45 GHz for a period of 2 min. The maximum temperature achieved as a result of the exposure was 87° C.

### Example 28

A Corning code 9667 (beta-spodumene) glass ceramic substrate was coated with a sputtered carbon coat. The article was exposed to 1200 W of microwave energy at 2.45 GHz for a period of 2 min. The maximum temperature achieved as a result of the exposure was 88° C.

### Example 29

A Kovar® glass frit (crushed glass) mixed with 0× steel wool fibers (23 g frit+>1 g steel wool) was melted in conventional oven overnight at 1100° C. The mixture was cooled to room temperature, and then the mixture was exposed to 1200 W of microwave energy at 2.45 GHz for a period of 2 min. The maximum temperature achieved as a result of the exposure was 91.5° C.

### Example 30

A Corning code 9696 (beta-eucryptite) glass cullet mixed with 30 wt % 16 grit silicon carbide particles, was melted for 8 hrs at 1450° C. The glass/particle mixture was removed from the oven and cooled to room temperature. A portion of the mixture was exposed to 1200 W of microwave energy at 2.45 GHz for a period of 2 min. The maximum temperature achieved as a result of the exposure was 92° C.

### Example 31

A high purity fused silica (HPFS®) with a conductive silver ink pattern printed on the surface was dried for 2 hours at 100° C. (printed at Corning Inc., 4^{th} printing). The article was allowed to cool to room temperature and then exposed to 1200 W of microwave energy at 2.45 GHz for a period of 2 min. The maximum temperature achieved as a result of the exposure was 93° C.

### Example 32

A high purity fused silica (HPFS®) sheet with a conductive silver ink pattern printed on the surface, and two sheets were placed together ink-to-ink (printed at Corning Inc.). The article was exposed to 1200 W of microwave energy at 2.45 GHz for a period of 2 min. The maximum temperature achieved as a result of the exposure was 93.6° C.

### Example 33

A high purity fused silica (HPFS®) sheet with a conductive silver ink dot printed on the surface (printed at Corning Incorporated). The article was exposed to 1200 W of microwave energy at 2.45 GHz for a period of 2 min. The maximum temperature achieved as a result of the exposure was 95.3° C.

### Example 34

A Corning code 9667 (beta-spodumene) glass ceramic substrate was coated with 300 nm sputtered silicon carbide coating. The coated article was exposed to 1200 W of microwave energy at 2.45 GHz for a period of 2 min. The maximum temperature achieved as a result of the exposure was 147° C. The coating was placed face down and a 100 mL water load was placed in the cavity.

### Example 35

A Corning code 9667 (beta-spodumene) glass ceramic substrate was coated with 800 nm sputtered aluminium coating. The coated article was exposed to 1200 W of microwave energy at 2.45 GHz for a period of 3 min. The maximum temperature achieved as a result of the exposure was 151° C.

### Example 36

A Corning code 9667 (beta-spodumene) glass ceramic substrate was brushed with a formula containing 50 wt % aluminium metal then another piece of the 9667 substrate was placed over the coated surface (e.g., see FIG. 6). The combined pieces were fired for 18 hours at 1000° C. The room temperature cooled article was then exposed to 1200 W of microwave energy at 2.45 GHz for a period of 2 min. The maximum temperature achieved as a result of the exposure was 103° C.

### Example 37

A Corning code 9667 (beta-spodumene) glass ceramic substrate was brushed with a commercial glaze and then a small amount of 3× steel wool (<1 g) was sprinkled over the wet glaze. The article was fired for 23 hours at 1000° C. The room temperature cooled article was then exposed to 1200 W of microwave energy at 2.45 GHz for a period of 2 min. The maximum temperature achieved as a result of the exposure was 108° C.

### Example 38

A Cordierite ceramic substrate having a glass frit with 30 wt % aluminium was sprayed on one surface at room temperature was then fired for 2 hours at 750° C. The room temperature cooled article was exposed to 1200 W of microwave energy at 2.45 GHz for a period of 2 min. The maximum temperature achieved as a result of the exposure was 121° C.

### Example 39

A Corning code 9696 (beta-eucryptite) glass cullet was mixed with 10 wt % 16 grit silicon carbide particles and melted for 8 hours at 1450° C. The mixture was removed from the oven and allowed to cool to room temperature. A portion of the mixture was exposed to 1200 W of microwave energy at 2.45 GHz for a period of 2 min. The maximum temperature achieved as a result of the exposure was 129° C.

### Example 40

A Corning Eagle XG™ glass substrate with titanium coated surface (thickness was not measured) was scratched or abraded with SiC paper. The sample was exposed to 1200 W of microwave energy at 2.45 GHz for a period of 2 min. The maximum temperature achieved as a result of the exposure was 130° C.

### Example 41

A Corelle® bowl laminate substrate having a 111 nm coating of tungsten deposited by sputter deposition in a vacuum on a major surface. The metalized substrate was exposed to 1200 W of microwave energy at 2.45 GHz for a period of 1 min. The maximum temperature achieved as a result of the exposure was 66° C.

### Example 42

A Corning code 9696 (beta-eucryptite) glass cullet was mixed with 20 wt % 16 grit silicon carbide particles, and melted for 8 hours at 1450° C. The mixture was removed from the oven and cooled to room temperature. A portion of the mixture was exposed to 1200 W of microwave energy at 2.45 GHz for a period of 2 min. The maximum temperature achieved as a result of the exposure was 148° C.

### Example 43

An extruded green Cordierite ceramic substrate slug was shaped and cured in a furnace for 2 hours at 400° C., 2 hours at 800° C., and then 8 hrs at 1150° C. The fired article was cooled to room temperature and then exposed to 1200 W of microwave energy at 2.45 GHz for a period of 2 min. The maximum temperature achieved as a result of the exposure was 155° C.

### Example 44

A Corning code 9667 (beta-spodumene) glass ceramic substrate was brushed with a commercial glaze mixed with 50 wt % aluminum frit and then fired at 1000° C. for 18 hours. The article was cooled to room temperature and then exposed to 1200 W of microwave energy at 2.45 GHz for a period of 2 min. The maximum temperature achieved as a result of the exposure was 168° C.

### Example 45

A Cordierite ceramic filter piece was filled with 16 grit silicon carbide particles and then exposed to 1200 W of microwave energy at 2.45 GHz for a period of 2 min. The maximum temperature achieved as a result of the exposure was 184° C.

### Example 46

A Corning code 9696 (beta-eucryptite) glass cullet was mixed with 50 wt % 16 grit silicon carbide particles, and melted for 8 hrs at 1450° C. The mixture was removed from the oven and allowed to cool to room temperature. A portion of the mixture was exposed to 1200 W of microwave energy at 2.45 GHz for a period of 2 min. The maximum temperature achieved as a result of the exposure was 188° C.

### Example 47

The smooth surface of a piece of Pyroceram® glass ceramic material was sputter-coated with 50 nm of stainless steel followed by a 3 nm coating of silica (protective layer to help prevent oxidation). The article was exposed to 1200 W of microwave energy at 2.45 GHz for a period of 1 min. The maximum temperature achieved as a result of the exposure was 94° C.

### Example 48

A Corning code 9667 (beta-spodumene) glass ceramic substrate was brushed with conductive carbon paint (DAG-T-502 Carbon Paint, Ted Pella, Inc. Redding, Calif.). The article was exposed to 1200 W of microwave energy at 2.45 GHz for a period of 2 min. The maximum temperature achieved as a result of the exposure was 191° C.

### Example 49

A fired Cordierite cookie with 0.2115 inch square openings (about 4 openings/inch) was used. Silicon carbide particles (16 grit) were used to fill 4 connecting openings (to form a larger square of about 0.42×0.42 in)) with 2 open squares between the 4 filled squares until a grid pattern was obtained. The article was then exposed to 1200 W of microwave energy at 2.45 GHz for a period of 5 min. The maximum temperature achieved as a result of the exposure was 501° C.

### Example 50

A mixture of alumina and bentonite clay mixed with steel wool fibers (4 g alumina (99.6%), 1 g bentonite, and 0.5 g steel wool fibers) was pressed into a 0.5 in diameter pellet. The pellet was exposed to 1200 W of microwave energy at 2.45 GHz for a period of 2 min. The maximum temperature achieved as a result of the exposure was 217° C.

### Example 51

A Cordierite ceramic filter piece was brushed with a mixture of silicon carbide particles suspended in a borosilicate resin (Somos® WaterClear® Ultra 10122, DSM Functional Groups, Elgin, Ill.) and then exposed to 1200 W of microwave energy at 2.45 GHz for a period of 2 min. The maximum temperature achieved as a result of the exposure was 229° C.

### Example 52

The textured side of a piece Pyroceram® glass ceramic material coated with 50 nm of stainless steel followed by a 3 nm coating of silica (protective layer to help prevent oxidation). The coated article was exposed to 1200 W of microwave energy at 2.45 GHz for a period of 1 min. The maximum temperature achieved as a result of the exposure was 129° C.

### Example 53

A Corning code 9667 (beta-spodumene) glass ceramic substrate was sputter coated with 50 nm stainless steel and then exposed to 1200 W of microwave energy at 2.45 GHz for a period of 2 min. The maximum temperature achieved as a result of the exposure was 283° C.

### Example 54

A Corning Willow® glass was coated with graphite and then exposed to 1200 W of microwave energy at 2.45 GHz for a period of 2 min. The maximum temperature achieved as a result of the exposure was of 287° C.

### Example 55

A Corning code 9667 (beta-spodumene) glass ceramic substrate was brushed with a glaze containing a mixture of carbon and aluminium. A second 9667 substrate was placed on top of the glaze and heated at 650° C. for 1 hr. The article was cooled room temperature and then exposed to 1200 W of microwave energy at 2.45 GHz for a period of 2 min. The maximum temperature achieved as a result of the exposure was 293° C.

### Example 56

A borosilicate glass slide coated with 200 nm of niobium was exposed to 1200 W of microwave energy at 2.45 GHz for a period of 2 min. The maximum temperature achieved as a result of the exposure was 314° C.

### Example 57

A Corning code 9667 (beta-spodumene) glass ceramic substrate was sputter coated with 7 nm of tantalum and then exposed to 1200 W of microwave energy at 2.45 GHz for a period of 2 min. The maximum temperature achieved as a result of the exposure was 334° C.

### Example 58

A mixture of alumina and bentonite clay was mixed with steel wool fibers (4 g alumina (99.6%), 1 g bentonite and 1.6 g steel wool fibers) then pressed into a 0.5 inch diameter pellet. The pellet was then exposed to 1200 W of microwave energy at 2.45 GHz for a period of 2 min. The maximum temperature achieved as a result of the exposure was 341° C.

### Example 59

A Corning code 9667 (beta-spodumene) glass ceramic substrate was sputter coated with 13 nm of molybdenum and then exposed to 1200 W of microwave energy at 2.45 GHz for a period of 2 min. The maximum temperature achieved as a result of the exposure was 343° C.

### Example 60

The inner surface of a masked Corelle® glass laminate bowl was sputter coated in a grid pattern with 50 nm of stainless steel and then exposed to 1200 W of microwave energy at 2.45 GHz for a period of 2 min. The bowl interior was masked off using tape to create the grid. The grid consisted of about 0.25 cm open/sputtered squares with the pattern covering the entire interior surface of the bowl. The maximum temperature achieved as a result of the exposure was 352° C.

### Example 61

The inner surface of a Corelle® glass laminate bowl was sputter coated with 50 nm of tin and then exposed to 1200 W of microwave energy at 2.45 GHz for a period of 2 min. The maximum temperature achieved as a result of the exposure was 352° C.

### Example 62

The inner surface of a Corelle® glass laminate bowl was coated with 34 nm of copper and then exposed to 1200 W of microwave energy at 2.45 GHz for a period of 2 min. The maximum temperature achieved as a result of the exposure was 188° C.

### Example 63

A borosilicate glass slide coated with 200 nm of titanium was exposed to 1200 W of microwave energy at 2.45 GHz for a period of 2 min. The maximum temperature achieved as a result of the exposure was 383° C.

### Example 64

High purity fused silica (HPFS®) was sputter coated with a 15 nm layer of titanium followed by a 20 nm layer of chrome. The article was exposed to 1200 W of microwave energy at 2.45 GHz for a period of 1 min. The maximum temperature achieved as a result of the exposure was 200° C.

### Example 65

A Corning code 9667 (beta-spodumene) glass ceramic substrate was provided to Heraeus (Germany) and printed with a conductive copper ink (dried) the printed article was then exposed to 1200 W of microwave energy at 2.45 GHz for a period of 30 sec. The maximum temperature achieved as a result of the exposure was 100° C.

### Example 66

A Corning code 9667 (beta-spodumene) glass ceramic substrate was sputter coated with 100 nm of tungsten and then exposed to 1200 W of microwave energy at 2.45 GHz for a period of 2 min. The maximum temperature achieved as a result of the exposure was 406° C.

### Example 67

A MACOR® glass ceramic substrate was sputter coated with 35-40 nm of stainless steel and then exposed to 1200 W of microwave energy at 2.45 GHz for a period of about 55 (sample broke at 50 secs) sec. The maximum temperature achieved as a result of the exposure was 196° C.

### Example 68

A Corning code 9667 (beta-spodumene) glass ceramic substrate was sputter coated with 100 nm of stainless steel and then exposed to 1200 W of microwave energy at 2.45 GHz for a period of 2 min. The maximum temperature achieved as a result of the exposure was 429° C.

### Example 69

A Corning code 9667 (beta-spodumene) glass ceramic substrate was sputter coated with stainless steel and then exposed to 1200 W of microwave energy at 2.45 GHz using a k-type thermocouple to record temperature. The sample arced within the first few seconds, no data.

### Example 70

A Corning code 9667 (beta-spodumene) glass ceramic substrate was sputter coated with stainless steel (same sample as C69) and then exposed to 1200 W of microwave energy at 2.45 GHz for a period of 3 min using a k-type thermocouple to record temperature. The maximum temperature achieved as a result of the exposure was 660° C.

### Example 71

A High purity fused silica (HPFS®) was sputter coated with a 120 nm layer of molybdenum. The article was exposed to 1200 W of microwave energy at 2.45 GHz for a period of 2 min. The maximum temperature achieved as a result of the exposure was 440° C.

### Example 72

A Corning code 9667 (beta-spodumene) glass ceramic substrate was coated with conductive carbon paint (DAG-T-502 Carbon Paint, Ted Pella, Inc., Redding, Calif.). The coating was applied by hand (thickness was not measured) in a grid pattern and then exposed to 1200 W of microwave energy at 2.45 GHz for a period of 2 min. The maximum temperature achieved as a result of the exposure was 447° C.

### Example 73

A Corning code 9667 (beta-spodumene) glass ceramic substrate placed on top of a titanium coated glass. This was the second heating for sample article of Example 99, as the sample had oxidized during the initial heating; the heating rate was diminished in this second trial. The article was exposed to 1200 W of microwave energy at 2.45 GHz for a period of 2 min. The maximum temperature achieved as a result of the second exposure was 448° C.

### Example 74

A high purity fused silica (HPFS®) was sputter coated with a 15 nm layer of titanium followed by a 40 nm layer of chrome. The article was exposed to 1200 W of microwave energy at 2.45 GHz for a period of 1 min. The maximum temperature achieved as a result of the exposure was 225° C.

### Example 75

A MACOR® glass ceramic substrate was sputter coated with 40 nm of stainless steel and then exposed to 1200 W of microwave energy at 2.45 GHz for a period of 1 min. The maximum temperature achieved as a result of the exposure was 238° C.

### Example 76

A borosilicate glass slide (Corning Microslide 2947) coated with titanium (thickness not measured) was exposed to 1200 W of microwave energy at 2.45 GHz for a period of 2 min. The maximum temperature achieved as a result of the exposure was 498° C.

### Example 77

A Corning code 9667 (beta-spodumene) glass ceramic substrate was sputter coated with 350 nm of stainless steel and then exposed to 1200 W of microwave energy at 2.45 GHz for a period of 2 min. The maximum temperature achieved as a result of the exposure was 502° C.

### Example 78

A VYCOR® glass sheet sputter coated with 46 nm of stainless steel and then exposed to 1200 W of microwave energy at 2.45 GHz for a period of 1 min. The maximum temperature achieved as a result of the exposure was 254° C.

### Example 79

A Corning code 9667 (beta-spodumene) glass substrate was sputter coated with 200 nm of titanium and then a second piece of 9667 was placed on top. The article was exposed to 1200 W of microwave energy at 2.45 GHz for a period of 2 min. The maximum temperature achieved as a result of the exposure was 512° C.

### Example 80

A Corning code 9667 (beta-spodumene) a glass substrate was coated with titanium. The materials were exposed to 1200 W of microwave energy at 2.45 GHz for a period of 2 min. The maximum temperature achieved as a result of the exposure was 524° C.

### Example 81

A mixture of alumina and bentonite clay mixed with steel wool fibers and aluminum filings (4 g alumina (99.6%), 1 g bentonite and 0.25 g steel wool fibers/filings) was pressed into a 0.5 inch diameter pellet. The pellet was then exposed to 1200 W of microwave energy at 2.45 GHz for a period of 2 min. The maximum temperature achieved as a result of the exposure was 525° C.

### Example 82

A Corning EagleXG™ glass substrate was printed with conductive silver ink (thickness not measured, printed at Corning, Incorporated) (second trial for this sample, see also Example 93). The article was exposed to 1200 W of microwave energy at 2.45 GHz for a period of 0.75 min. The maximum temperature achieved as a result of the exposure was 225° C.

### Example 83

A Corelle® bowl glass-laminate substrate was sputter coated with 50 nm titanium. The article was exposed to 1200 W of microwave energy at 2.45 GHz for a period of 2 min. The maximum temperature achieved as a result of the exposure was 656° C.

### Example 84

A Corelle® bowl glass-laminate substrate was sputter coated with 35-40 nm stainless steel. The article was exposed to 1200 W of microwave energy at 2.45 GHz for a period of 2 min. The maximum temperature achieved as a result of the exposure was 670° C. The sample survived 4-5 heating/cooling cycles without breaking.

### Example 85

A Corelle® bowl glass-laminate substrate was sputter coated with 35 to 40 nm stainless steel followed by a 10 nm coating of silica. The article was exposed to 1200 W of microwave energy at 2.45 GHz for a period of 2 min. The maximum temperature achieved as a result of the exposure was 670° C. The article would typically survive 4 to 5 heating/cooling cycles without breaking.

### Example 86

A Corning code 9667 (beta-spodumene) glass substrate was coated with copper (thickness not measured). The article was exposed to 1200 W of microwave energy at 2.45 GHz for a period of 2 min. The maximum temperature achieved as a result of the exposure was 670.2° C.

### Example 87

A Corning code 9667 (beta-spodumene) glass substrate was coated with titanium (thickness not measured). A 100 ml beaker of water added to cavity to help alleviate arcing. The article was exposed to 1200 W of microwave energy at 2.45 GHz for a period of 1 min. The maximum temperature achieved as a result of the exposure was 350° C.

### Example 88

A Corelle® bowl glass-laminate substrate was sputter coated with 194 nm molybdenum. The article was exposed to 1200 W of microwave energy at 2.45 GHz for a period of 1 min. The maximum temperature achieved as a result of the exposure was 391° C. The article was heavily oxidized after the initial heating.

### Example 89

A Corning code 9696 (beta-eucryptite) glass ceramic substrate, and silicon carbide powder (Carborex C6-100, 150 μm diameter particles—low loading) was placed on the surface of one sheet of the glass ceramic substrate, then a second substrate sheet of 9696 glass ceramic was placed over the silicon carbide. The temperature was measured with k-type thermocouple. The temperature exceeded the limit of thermocouple (1200° C.) in 3 minutes, the sample melted and the thermocouple fused to sample.

### Example 90

A Corning code 9667 (beta-spodumene) glass substrate was coated with titanium and chrome (15 nm/20 nm). The article was exposed to 1200 W of microwave energy at 2.45 GHz for a period of 1 min. The maximum temperature achieved as a result of the exposure was 430° C.

### Example 91

A Corning code 9667 (beta-spodumene) glass substrate was coated with aluminium (thickness not measured). The article was exposed to 1200 W of microwave energy at 2.45 GHz for a period of 2 min. The maximum temperature achieved as a result of the exposure was 900° C. Some arcing at front edge, refractories under the sample were glowing.

### Example 92

A Corning Willow® glass substrate was coated with indium-tin oxide (thickness not measured). The coated article was exposed to 120 W of microwave energy at 2.45 GHz for a period of about 66 sec. The maximum temperature achieved as a result of the exposure was 500° C. The glass slumped, and the edges were deformed.

### Example 93

A Corning EagleXG™ glass substrate printed with conductive silver ink (thickness not measured) (initial trial for this sample, see also Example 82). The sample was exposed to 1200 W of microwave energy at 2.45 GHz for a period of 0.5 minutes with a maximum temperature of 250° C. This sample meets the target heating rate limit, but the substrate broke.

### Example 94

Corning code 9667 (beta-spodumene) a glass substrate was sputter coated with 23 nm stainless steel in a grid pattern. The article was exposed to 1200 W of microwave energy at 2.45 GHz for a period of 1 min. The maximum temperature achieved as a result of the exposure was 670° C. There was partial melting of the substrate.

### Example 95

A Corelle® bowl glass-laminate substrate was sputter coated with 15 nm stainless steel. The article was exposed to 1200 W of microwave energy at 2.45 GHz for a period of 1 min. The maximum temperature achieved as a result of the exposure was 670° C.

### Example 96

A Corelle® bowl glass-laminate substrate was sputter coated with 35 to 40 nm stainless steel. The article was exposed to 1200 W of microwave energy at 2.45 GHz for a period of 1 min. The maximum temperature achieved as a result of the exposure was 670° C.

### Example 97

A molded article made of Corning code 9667 (beta-spodumene) was sputter coated with 800 nm aluminium. The materials were exposed to 1200 W of microwave energy at 2.45 GHz for a period of 1.15 minutes with a maximum temperature of 900° C. The substrate melted and vitrified.

### Example 98

A Corning code 9696 (beta-eucryptite) glass ceramic substrate and silicon carbide powder (Carborex C6-100, 150 micron diameter particles—high loading) was placed on the surface of one sheet of the glass ceramic substrate, and then a second sheet was placed over the silicon carbide powder. The temperature was measured with a k-type thermocouple placed under the sample. The article was exposed to 1200 W of microwave energy at 2.45 GHz for a period of about 0.53 min. The maximum temperature achieved as a result of the exposure was 500° C. The sample broke, arced several times.

### Example 99

A Corning code 9667 (beta-spodumene) substrate was used as a base sheet, then 4 pieces of 0.5 inch square glass pieces that were coated with titanium (thickness not measured) were placed on the sheet in a 2×2 pattern. A second sheet of the 9667 substrate was placed over the coated glass samples. The article was exposed to 1200 W of microwave energy at 2.45 GHz for a period of 2 min. The maximum temperature achieved as a result of the exposure was 620° C. was achieved after 30 seconds.

### Example 100

A high purity fused silica (HPFS®) substrate was heated to 750° C. and then sprayed with a glass frit formulation containing 30 wt % aluminum. A high purity fused silica (HPFS®) substrate was sputter coated with a 120 nm layer of molybdenum. The combined substrates were exposed to 1200 W of microwave energy at 2.45 GHz for a period of 2 minutes with a maximum temperature of 440° C.

### Example 101

A Pyroceram® sheet was sputter coated with 25 nm of stainless steel followed by a 3 nm coating of silica. The materials were exposed to 1200 W of microwave energy at 2.45 GHz for a period of 0.5 minutes with a maximum temperature of 670° C. Sample broke on cooling.

### Example 102

A Pyroceram® sheet was sputter coated with 25 nm of stainless steel followed by a 3 nm coating of silica. The article was exposed to 1200 W of microwave energy at 2.45 GHz for a period of 0.5 min. The maximum temperature achieved as a result of the exposure was 670° C. This was the second heating for this sample (see first heating in Example 101), which had arcing on the surface, and the sample broke during heating.

### Example 103

A Corning code 9667 (beta-spodumene) substrate was coated with a conductive silver paste. The article was exposed to 1200 W of microwave energy at 2.45 GHz for a period of 0.45 min. The maximum temperature achieved as a result of the exposure was 670° C. The sample melted.

### Example 104

A fired clay dish was heated to 750° C. and then a glass frit containing 25 wt % aluminum was sprayed on the interior surface. The article was exposed to 1200 W of microwave energy at 2.45 GHz for a period of 0.25 min. The maximum temperature achieved as a result of the exposure was 670° C. The dish showed minor cracks in the surface but did not break.

### Example 105

A Corning code 9667 (beta-spodumene) substrate was coated with a conductive silver paste. The article was exposed to 1200 W of microwave energy at 2.45 GHz for a period of 0.18 min. The maximum temperature achieved as a result of the exposure was 670° C. The sample melted.

The disclosure has been described with reference to various specific embodiments and techniques. However, it should be understood that many variations and modifications are possible while remaining within the scope of the disclosure.

TABLE 1
Literature Reported Measured Maximum Temperatures
of Various Materials in a 2.45 GHz Microwave
at 1000 W for a Specified Time.

| | Tₘₐₓ | Time | Heating Rate |
|---|---|---|---|
| Material | (° C.) | (min) | (° C./sec) |
| Alumina | 78 | 4.5 | 0.29 |
| Calcium Carbonate | 54 | 7 | 0.13 |
| Amorphous Carbon | 1283 | 1 | 21.4 |
| Manganese Oxide | 1287 | 6 | 3.6 |
| Tungsten Oxide | 1270 | 6 | 3.53 |
| Al (powder) | 577 | 6 | 1.6 |
| Mo (powder) | 660 | 4 | 2.75 |
| Fe (powder) | 768 | 7 | 1.83 |

TABLE 2
Summary of Controls, Commercial Products, and Experimental Articles for
Rapid Heating in a 1200 W, 2.45 GHz Microwave.

| | | | | | Coating | | | |
|---|---|---|---|---|---|---|---|---|
| | | | | | Thickness | | | |
| | Product or | | | | ( nm) | | | Heating |
| | Physical | | | Susceptor/ | Particle | | Tₘₐₓ | Rate |
| Example | Description | Material | Form | Reflector | (wt %) | | (° C.) | (° C./sec) |
| C-1 | beta- | glass- | Device | none | no coating | | 42 | 0.7 |
| | spodumene | ceramic | | | | | | |
| C-2 | Corelle ® | laminated | Bowl | none | no coating | | 44 | 0.7 |
| | | glass | | | | | | |
| C-3 | beta- | glass- | Device | none | no coating | | 46 | 0.8 |
| | spodumene | ceramic | | | | | | |
| C-4 | beta- | glass- | flat | none | no coating | | 64 | 1.1 |
| | eucryptite | ceramic | sheet | | | | | |
| C-5 | beta- | glass- | flat | none | no coating | | 64 | 1.1 |
| | eucryptite | ceramic | sheet | | | | | |
| C-6 | Corelle ® | laminated | Bowl | none | no coating | | 81 | 1.4 |
| | | glass | | | | | | |
| C-7 | Commercial | plastic | Grill | magnetite paste | not measured | | 148 | 0.1 |
| | Bacon Grill | and | | applied under | | | | |
| | | metal | | the metal grill | | | | |
| C-8 | Progressive | plastic | Grill | unknown | no coating | | 39 | 0.7 |
| | Prepsolutions | | | | | | | |
| | Bacon Grill | | | | | | | |
| C-9 | CorningWare ® | glass- | Pan | tin/antimony | not measured | | 240 | 0.9 |
| | | ceramic | | | | | | |
| C-10 | Commercial | metal | Grill | metal | no coating | | 240 | 1.0 |
| | Grill Pan | | | | | | | |
| C-11 | DiGiorno ® | paper/foil | Package | foil | not measured | | 272 | 1.1 |
| | Package | | | | | | | |
| C-12 | Presto Power | paper | Cup | metallic film | not measured | | 87 | 1.5 |
| | Cup ® | | | | | | | |
| C-13 | Marie | paper | Package | metallic film | not measured | | 260 | 2.2 |
| | Calendar's ® | | | on paper | | | | |
| | Package | | | | | | | |
| C-14 | Brown&Crisp ® | paper | Bag | metallic film | not measured | | 270 | 4.1 |
| | Microwave | | | | | | | |
| | Cooking Bags | | | | | | | |
| 15 | beta- | glass- | flat | iron powder | not measured | | nd | 0.0 |
| | eucryptite | ceramic/ | sheet | low loading | | | | |
| | | glass | | between 2 | | | | |
| | | ceramic | | sheets | | | | |
| 16 | beta- | glass- | flat | iron powder | not measured | | nd | 0.0 |
| | eucryptite | ceramic/ | sheet | medium | | | | |
| | | glass | | loading | | | | |
| | | ceramic | | between 2 | | | | |
| | | | | sheets | | | | |
| 17 | beta- | glass- | flat | iron powder | not measured | | nd | 0.0 |
| | eucryptite | ceramic/ | sheet | high loading | | | | |
| | | glass | | between 2 | | | | |
| | | ceramic | | sheets | | | | |
| 18 | beta- | glass- | flat | silicon | not measured | | nd | 0.0 |
| | eucryptite | ceramic/ | sheet | carbide- | | | | |
| | | glass | | medium | | | | |
| | | ceramic | | loading | | | | |
| | | | | between 2 | | | | |
| | | | | sheets | | | | |
| 19 | beta- | glass- | flat | tin | 6000 | nm | 87 | 0.5 |
| | spodumene | ceramic | sheet | | | | | |
| 20 | PYREX ® | glass | flat | printed | not measured | | 60 | 0.5 |
| | | | sheet | conductive | | | | |
| | | | | ink | | | | |
| 21 | beta- | glass- | flat | carbon coated | not measured | | 64 | 0.5 |
| | spodumene | ceramic | sheet | with | | | | |
| | | | | commercial | | | | |
| | | | | clear glaze | | | | |
| 22 | beta- | glass- | flat | stainless steel | not measured | | 71 | 0.6 |
| | spodumene | ceramic | sheet | tubes with | | | | |
| | | | | commercial | | | | |
| | | | | clear glaze | | | | |
| 23 | HPFS ® | glass | flat | conductive | not measured | | 77 | 0.6 |
| | | | sheet | ink | | | | |
| 24 | beta- | glass- | molded | silicon carbide | 300 | nm | 122 | 0.7 |
| | spodumene | ceramic | sheet | | | | | |
| 25 | beta- | glass- | flat | carbon | not measured | | 82 | 0.7 |
| | spodumene | ceramic | sheet | | | | | |
| 26 | Kovar ® | glass | flat | 3X steel wool | not measured | | 86 | 0.7 |
| | | | sheet | mixed with | | | | |
| | | | | Kovar frit | | | | |
| 27 | beta- | glass- | flat | carbon coated | not measured | | 87 | 0.7 |
| | spodumene | ceramic | sheet | with | | | | |
| | | | | commercial | | | | |
| | | | | clear glaze | | | | |
| 28 | beta- | glass- | flat | carbon | not measured | | 88 | 0.7 |
| | spodumene | ceramic | sheet | | | | | |
| 29 | Kovar ® | glass | flat | 0x steel wool | not measured | | 92 | 0.8 |
| | | | sheet | mixed in with | | | | |
| | | | | Kovar ® frit | | | | |
| 30 | beta- | glass | chunk | silicon carbide | 30 | wt % | 92 | 0.8 |
| | eucryptite | | | particles mixed | | | | |
| | | | | in with cullet | | | | |
| 31 | HPFS ® | glass | flat | conductive | not measured | | 93 | 0.8 |
| | | | sheet | ink | | | | |
| 32 | HPFS ® | glass | 2 flat | conductive ink | not measured | | 94 | 0.8 |
| | | | sheets | between two | | | | |
| | | | | sheets | | | | |
| 33 | HPFS ® | glass | flat | conductive | not measured | | 95 | 0.8 |
| | | | sheet | ink | | | | |
| 34 | beta- | glass- | flat | silicon carbide | 300 | nm | 147 | 0.8 |
| | spodumene | ceramic | sheet | | | | | |
| 35 | beta- | glass- | flat | aluminum | 800 | nm | 151 | 0.8 |
| | spodumene | ceramic | sheet | | | | | |
| 36 | beta- | glass- | flat | frit containing | 30 | wt % | 103 | 0.9 |
| | spodumene | ceramic | sheet | 30 wt % | | | | |
| | | | | aluminum | | | | |
| | | | | between | | | | |
| | | | | 2 sheets | | | | |
| 37 | beta- | glass- | flat | commercial | not measured | | 108 | 0.9 |
| | spodumene | ceramic | sheet | glaze brushed | | | | |
| | | | | on sheet, 3X | | | | |
| | | | | steel wool | | | | |
| | | | | sprinkled into | | | | |
| | | | | wet glaze | | | | |
| 38 | cordierite | ceramic | filter | glass frit with | 30 | wt % | 121 | 1.0 |
| | | | | 30 wt % | | | | |
| | | | | aluminum | | | | |
| | | | | sprayed on | | | | |
| | | | | room | | | | |
| | | | | temperature | | | | |
| | | | | surface | | | | |
| 39 | beta- | glass | chunk | silicon carbide | 10 | wt % | 129 | 1.1 |
| | eucryptite | | | particles mixed | | | | |
| | cullet | | | in with cullet | | | | |
| 40 | EagleXG ® | glass | flat | titanium | not measured | | 130 | 1.1 |
| | | | sheet | | | | | |
| 41 | Corelle ® | laminate | bowl | tungsten | 111 | nm | 66 | 1.1 |
| 42 | beta- | glass | chunk | silicon carbide | 20 | wt % | 148 | 1.2 |
| | eucryptite | | | particles mixed | | | | |
| | cullet | | | in with cullet | | | | |
| 43 | cordierite | ceramic | flat | silicon carbide | not measured | | 155 | 1.3 |
| | | | sheet | particles in grid | | | | |
| | | | | pattern | | | | |
| 44 | beta- | glass- | flat | glass frit with | not measured | | 168 | 1.4 |
| | spodumene | ceramic | sheet | aluminum | | | | |
| | | | | metal 50 wt % | | | | |
| | | | | 1000° C. for 18 | | | | |
| | | | | hours | | | | |
| 45 | cordierite | ceramic | filter | silicon carbide | not measured | | 184 | 1.5 |
| | | | | particles 16 grit | | | | |
| | | | | in a preformed | | | | |
| | | | | filter | | | | |
| 46 | beta- | glass | flat | silicon carbide | 50 | wt % | 188 | 1.6 |
| | eucryptite | | sheet | particles mixed | | | | |
| | cullet | | | in with cullet | | | | |
| 47 | Pyroceram ® | glass- | flat | silica on | 3 nm/50 nm | | 94 | 1.6 |
| | | ceramic | sheet | stainless steel | | | | |
| 48 | beta- | glass- | flat | carbon | not measured | | 191 | 1.6 |
| | spodumene | ceramic | sheet | conductive | | | | |
| | | | | paint | | | | |
| 49 | cordierite | ceramic | filter | silicon carbide | not measured | | 501 | 1.7 |
| | | | | 16 grt in grid | | | | |
| | | | | pattern | | | | |
| 50 | alumina/clay | pellet | pellet | steel wool | 0.5 | g | 217 | 1.8 |
| | | | | fibers/aluminum | | | | |
| | | | | filings | | | | |
| 51 | cordierite | ceramic | filter | silicon carbide | not measured | | 229 | 1.9 |
| | | | | with | | | | |
| | | | | borosilicate | | | | |
| | | | | resin | | | | |
| 52 | Pyroceram ® | glass- | flat | silica on | 3 nm/50 nm | | 129 | 2.2 |
| | | ceramic | sheet | stainless steel | | | | |
| 53 | beta- | glass- | flat | stainless steel | 50 | nm | 283 | 2.4 |
| | spodumene | ceramic | sheet | | | | | |
| 54 | Willow ® | glass | flat | graphite | not measured | | 287 | 2.4 |
| | | | sheet | | | | | |
| 55 | beta- | glass- | flat | aluminum | not measured | | 293 | 2.4 |
| | spodumene | ceramic/ | sheet | glaze over | | | | |
| | | glass | | carbon | | | | |
| | | ceramic | | | | | | |
| 56 | borosilicate | glass | flat | niobium | 200 | nm | 314 | 2.6 |
| | | | sheet | | | | | |
| 57 | beta- | glass- | flat | tantalum | 7 | nm | 334 | 2.8 |
| | spodumene | ceramic | sheet | | | | | |
| 58 | alumina/clay | pellet | flat | steel wool | 1.6 | g | 341 | 2.8 |
| | | | sheet | fibers | | fibers | | |
| 59 | beta- | glass- | flat | molybdenum | 13 | nm | 343 | 2.9 |
| | spodumene | ceramic | sheet | | | | | |
| 60 | Corelle ® | laminate | bowl | stainless | 50 | nm | 352 | 2.9 |
| | | | | steel | | | | |
| | | | | grid | | | | |
| 61 | Corelle ® | laminate | bowl | tin | 50 | nm | 352 | 2.9 |
| 62 | Corelle ® | laminate | bowl | copper | 34 | nm | 188 | 3.1 |
| 63 | borosilicate | glass | flat | titanium | 200 | nm | 383 | 3.2 |
| | | | sheet | | | | | |
| 64 | HPFS ® | glass | flat | titanium and | 15 nm/20 nm | | 200 | 3.3 |
| | | | sheet | chrome | | | | |
| 65 | beta- | glass- | flat | Heraeus | not measured | | 100 | 3.3 |
| | spodumene | ceramic | sheet | printed | | | | |
| | | | | copper ink | | | | |
| 66 | beta- | glass- | flat | tungsten | 100 | nm | 406 | 3.4 |
| | spodumene | ceramic | sheet | | | | | |
| 67 | MACOR ® | glass- | flat | stainless steel | 35-40 | nm | 196 | 3.6 |
| | | ceramic | sheet | | | | | |
| 68 | beta- | glass- | flat | stainless steel | 100 | nm | 429 | 3.6 |
| | spodumene | ceramic | sheet | | | | | |
| 69 | beta- | glass- | flat | stainless steel | not measured | | <1150 | |
| | spodumene | ceramic | sheet | | | | | |
| 70 | beta- | glass- | flat | stainless steel | not measured | | 660 | 3.7 |
| | spodumene | ceramic | sheet | | | | | |
| 71 | HPFS ® | glass | flat | molybdenum | 120 | nm | 440 | 3.7 |
| | | | sheet | | | | | |
| 72 | beta- | glass- | flat | carbon | not measured | | 447 | 3.7 |
| | spodumene | ceramic | sheet | conductive | | | | |
| | | | | painted grid | | | | |
| 73 | glass/beta- | glass/ | flat | titanium coated | not measured | | 448 | 3.7 |
| | spodumene | glass- | sheet | glass with beta- | | | | |
| | | ceramic | | spodumene | | | | |
| | | | | sheet on top | | | | |
| 74 | HPFS ® | glass | flat | titanium and | 15 nm/40 nm | | 225 | 3.8 |
| | | | sheet | chrome | | | | |
| 75 | MACOR ® | glass- | flat | stainless steel | 40 | nm | 238 | 4.0 |
| | | ceramic | sheet | | | | | |
| 76 | borosilicate | glass | flat | titanium | not measured | | 498 | 4.2 |
| | | | sheet | | | | | |
| 77 | beta- | glass- | flat | stainless steel | 350 | nm | 502 | 4.2 |
| | spodumene | ceramic | sheet | | | | | |
| 78 | VYCOR ® | glass | flat | stainless steel | 46 | nm | 254 | 4.2 |
| | | | sheet | | | | | |
| 79 | beta- | glass/ | flat | titanium | 200 | nm | 512 | 4.3 |
| | spodumene | glass- | sheet | | | | | |
| | | ceramic | | | | | | |
| 80 | beta- | glass- | flat | titanium | not measured | | 524 | 4.4 |
| | spodumene | ceramic | sheet | | | | | |
| 81 | alumina/clay | pellet | pellet | steel | 0.25 | g | 525 | 4.4 |
| | | | | wool fibers | | | | |
| | | | | and aluminum | | | | |
| | | | | filings | | | | |
| 82 | EagleXG ® | glass | flat | conductive | not measured | | 225 | 5.0 |
| | | | sheet | silver ink | | | | |
| 83 | Corelle ® | laminate | bowl | titanium | 50 | nm | 656 | 5.5 |
| 84 | Corelle ® | laminate | bowl | stainless steel | 35-40 | nm | 670 | 5.6 |
| 85 | Corelle ® | laminate | bowl | silica on | 10 nm/23 nm | | 670 | 5.6 |
| | | | | stainless steel | | | | |
| 86 | beta- | glass- | flat | copper | not measured | | 670 | 5.6 |
| | spodumene | ceramic | sheet | | | | | |
| 87 | beta- | glass- | flat | titanium | not measured | | 350 | 5.8 |
| | spodumene | ceramic | sheet | | | | | |
| 88 | Corelle ® | laminate | bowl | molybdenum | 149 | nm | 391 | 6.5 |
| | | glass | | | | | | |
| 89 | beta- | glass- | flat | silicon carbide- | not measured | | <1200 | 6.7 |
| | eucryptite | ceramic/ | sheet | low loading | | | | |
| | | glass | | between 2 | | | | |
| | | ceramic | | sheets | | | | |
| 90 | beta- | glass- | flat | titanium and | 15 nm/20 nm | | 430 | 7.2 |
| | spodumene | ceramic | sheet | chrome | | | | |
| 91 | beta- | ceramic | flat | aluminum | not measured | | 900 | 7.5 |
| | spodumene | | sheet | | | | | |
| 92 | Willow ® | glass | flat | indium-tin | not measured | | 500 | 7.6 |
| | | | sheet | oxide | | | | |
| 93 | EagleXG ® | glass | flat | conductive | not measured | | 250 | 8.3 |
| | | | sheet | silver ink | | | | |
| 94 | beta- | glass- | flat | stainless steel | 23 | nm | 670 | 11.2 |
| | spodumene | ceramic | sheet | grid | | | | |
| 95 | Corelle ® | laminate | bowl | stainless steel | 15 | nm | 670 | 11.2 |
| | | glass | | | | | | |
| 96 | Corelle ® | laminate | bowl | stainless steel | 35-40 | nm | 670 | 11.2 |
| | | glass | | | | | | |
| 97 | beta- | glass- | device | aluminum | 800 | nm | 900 | 13.0 |
| | spodumene | ceramic | | | | | | |
| 98 | beta- | glass- | flat | silicon carbide- | not measured | | 500 | 15.7 |
| | eucryptite | ceramic/ | sheet | high loading | | | | |
| | | glass | | between 2 | | | | |
| | | ceramic | | sheets | | | | |
| 99 | beta- | glass- | flat | 4 pieces of | not measured | | 620 | 20.7 |
| | spodumene/ | ceramic/ | sheet | titanium coated | | | | |
| | glass | glass | | glass (0.5 in | | | | |
| | | | | square each) | | | | |
| | | | | with beta- | | | | |
| | | | | spodumene | | | | |
| | | | | sheet on top | | | | |
| 100 | HPFS ® | glass | flat | glass frit | 30 | wt % | 670 | 22.3 |
| | | | sheet | with 30 wt % | | | | |
| | | | | aluminum | | | | |
| | | | | sprayed on hot | | | | |
| | | | | surface | | | | |
| | | | | (750° C.) | | | | |
| 101 | Pyroceram ® | glass- | flat | silica on | 3 nm/25 nm | | 670 | 22.3 |
| | | ceramic | sheet | stainless steel | | | | |
| 102 | Pyroceram ® | glass- | flat | silica on | 3 nm/25 nm | | 670 | 22.3 |
| | | ceramic | sheet | stainless steel | | | | |
| 103 | beta- | glass- | flat | silver paste | not measured | | 670 | 24.8 |
| | spodumene | ceramic | sheet | | | | | |
| 104 | fired clay | ceramic | bowl | glass frit | 25 | wt % | 670 | 44.7 |

| | | | | | | | |
|---|---|---|---|---|---|---|---|
| | | | | with 25 wt % | | | |
| | | | | aluminum | | | |
| | | | | sprayed on hot | | | |
| | | | | surface | | | |
| | | | | (750° C.) | | | |
| 105 | beta- | glass- | flat | silver paste | not measured | 670 | 62.0 |
| | spodumene | ceramic | sheet | | | | |

TABLE 3
Preferred Inventive Combinations Based on Cost of Materials,
Fabrication Method, and Heating Rate Performance.

| | Overall Relative Cost - | | | | |
|---|---|---|---|---|---|
| | high, moderate, low | | | Heating | Overall |
| | Sub- | Coat- | Fabrica- | Rate | Ranking |
| Example | strate | ing | tion | (° C./sec) | (1 = superior) |
| 95 and 96 | Low | Low | Moderate | 11.2 | 1 |
| 100 | High | Low | Moderate | 22.3 | 2 |
| 99 | Moderate | High | High | 20.7 | 3 |
| 94 | Moderate | Low | Moderate | 11.2 | 4* |

*sample partially melted, modification to substrate may be necessary

What is claimed:

1. A microwave susceptor article comprising: a substrate having a thickness of from 2 to 10 mm; and a metallic-containing layer having a thickness of 10 to 800 nanometers on at least one major surface of the substrate, wherein the article has a microwave heating rate of from 8 to 45° C./sec.

2. The article of claim 1 wherein the substrate has: a thermal conductivity of from 0.002 to 0.004 Cal/cm−sec-° C.; a modulus of rupture (MOR) of from 40 to 550 MPa; and a coefficient of thermal expansion (CTE) of from 0 to 92×10⁻⁷/° C.

3. The article of claim 1 wherein the metallic-containing layer comprises a metal sheet, metal particles, metal wires, metal coils, metal wool, metal fibers, metal coated fibers, metal coated particles, or a combination thereof.

4. The article of claim 1 wherein the article has an ambient cooling rate, from an elevated temperature to ambient temperature, of from 10° C. per second to 75° C. per second.

5. The article of claim 1 wherein the microwave energy to achieve the microwave heating rate was from 50 to 2000 W, and the microwave source frequency is selected from 915 MHz, 2.45 GHz, 5.8 GHz, or combinations thereof.

6. The article of claim 1 wherein the microwave energy to achieve the microwave heating rate was from 1000 to 1400 W, and the microwave source frequency was 2.45 GHz.

7. The article of claim 1 wherein the substrate has thickness of from 2 to 6 mm, and the metallic-containing layer has thickness of from 10 to 500 nanometers.

8. The article of claim 1 wherein the substrate is sheet or structure of a glass, glass laminate, a glass-on-lass laminate, a glass ceramic, a glass-on-glass ceramic, a ceramic, or a combination thereof, and the metallic-containing layer is selected from a sputtered metal, a sprayed metal, printed metal, or a combination thereof.

9. The article of claim 1 wherein the metallic-containing layer is selected from aluminum, tin, tungsten, titanium, copper, molybdenum, silver, stainless steel, a metalloid compound silicon carbide, or a combination thereof.

10. The article of claim 1 further comprising a protective layer on or over the metallic containing layer, which prevents oxidation of the metal in the metallic containing layer.

11. The article of claim 1 wherein the substrate comprises a plurality of substrates having one or more of the interleaved metallic-containing layers between each of the substrates.

12. A method of making the article of claim 1 comprising:
depositing at least a metallic material to form a metallic containing layer on the substrate.

13. The method of claim 12 wherein depositing at least the metallic material on the substrate comprises:
sputter coating a metallic source to form a metallic layer on the substrate;
spraying a glaze formulation containing from 25 to 50 wt % based on 100 wt % of the glaze formulation, metallic particles on the surface of the substrate;
brushing a glaze formulation containing from 25 to 50 wt % based on 100 wt % of the glaze formulation, metallic particles on the surface of the substrate;
or a combination thereof.

14. A method of using the microwave susceptor article of claim 1 comprising:
irradiating the microwave susceptor article and a work piece with a source of microwaves for a time.

15. The method of claim 14 wherein the time is from 5 seconds to 10 minutes.

16. The method of claim 14 wherein the microwave susceptor article is in proximity to the work piece, the microwave susceptor article is in direct physical contact with the work piece, or both.

17. The method of claim 14 wherein the work piece is selected from at least one of: a food item, a wet ceramic body, a ceramic green body, a partially sintered ceramic, a sintered ceramic, timber, milled lumber, lumber composites, concrete, terrazzo, or combinations thereof.

18. The method of claim 14 wherein irradiating is sufficient to produce a temperature increase in the article from ambient to at least one of:
from 500 to 670° C. in 60 seconds;
from 500 to 670° C. in 30 seconds; or
from 500 to 670° C. in 20 seconds.

19. The method of claim 14 wherein the substrate is a glass-laminate and the metallic-containing layer is selected from steel, aluminum, titanium, or combinations thereof.

20. The method of claim 14 wherein the article has an ambient cooling rate of from 10° C. per second to 75° C. per second from an elevated temperature to ambient temperature.

21. The method of claim 14 wherein the source of microwaves had a source frequency of 2.45 GHz and was operated at 1200 W.

22. The article of claim 1 wherein the microwave energy to achieve the microwave heating rate was 1200 W, and the microwave source frequency was 2.45 GHz.
